(19) United States
(12) Patent Application Publication
(10) Pub. No.: US 2009/0071262 A1
(43) Pub. Date: Mar. 19, 2009

(54) ELECTRICALLY MEASURING EXPANSIONS ON CYLINDRICAL BODIES

(75) Inventor: Jean-Jacques Schmid, Frauenfeld (CH)

Correspondence Address: BACHMAN & LAPOINTE, P.C., 900 CHAPEL STREET, SUITE 1201, NEW HAVEN, CT, 06510, US

(73) Assignee: BAUMER HOLDING AG, Frauenfeld (CH)

(21) Appl. No.: 12/183,419

(22) Filed: Jul. 31, 2008

Related U.S. Application Data
(63) Continuation of application No. 11/909,286.

(30) Foreign Application Priority Data
Mar. 24, 2005 (CH) 510/05

(51) Int. Cl. G01N 3/02

(52) U.S. Cl. 73/859

(57) ABSTRACT

Positive and negative expansions on the covering surface of essentially cylindrical bodies are measured by mobile measuring pincers which comprise a guiding profile for two adjacently adjustable sliders which are used to clamp the body in a radial direction and to press at least one expansive measuring element on the covering surface by forming a frictional connection. Currently, a first slider, which can be displaced in the direction of clamping on the guide profile by a spindle, preferably comprising integrated torque adjustment, is offset with a centering element on the cylindrical head. Then, a second slider, which can be displaced on the guide profile is arranged with a centering element on the cylindrical body and engaged. The centering elements are clamped on the body between the sliders by pulling the spindle. The measuring element(s) are is/are pressed onto the covering surface of the body in order to form a positive connection. The sliders comprise a guide element for the centering elements of the cylindrical head in the head region thereof, which can be displaced counter to the resistance of at least one return spring in the direction of clamping (S). The centering elements have, preferably, essentially angular centre plates which can be exchanged.

### BACKGROUND OF THE INVENTION

(1) Field of the Invention

The invention relates to a method and an apparatus for electrical measurement of positive and negative strains on the outer surface of essentially cylindrical bodies, using a mobile clip-on instrument which has a guide profile for two slides, which can be adjusted with respect to one another, for clamping a body in the radial direction and for pressing at least one strain-sensitive measurement element onto the outer surface, forming a force fit.

(2) Prior Art

It is known for positive and negative strains on cylindrical bodies to be measured by exerting a high contact force on a measurement element. CH 887645 A5 describes a measured-value sensor in which an elastic element is pressed with the aid of two circular-ring halves onto the outer surface of the cylindrical body such that the strains which occur on its outer surface can be measured, by means of a force fit. Furthermore, the measurement object must have an exactly circular section at the measurement point, and these sensors are not intended for oval profiles or those with corners.

WO 01/84073 A1 describes a further-developed measured-value sensor which has more than two parts and is essentially annular. Two segments of the measured-value sensor each have a mutually opposite cutout diagonally in the tightening direction for a projecting elastic part with a measurement element. The measurement elements can be pressed onto the surface of the body, with a force fit, for strain measurement. The mutually diagonally opposite segments with the measurement elements can be clamped at both ends by means of replaceable and/or adjustable side guide members for the body to be measured. The same two segments with a measurement element can be used for different diameters and cross-sectional shapes of a body.

The data sheet “Messzange DSRZ” [Clip-on instrument DRSZ] from the Baurner sensopress AG Company, CH-8501 Frauenfeld discloses a variable instrument for strain measurements, in particular on the struts and cylinders of presses. This instrument allows infinitely variable diameter adjustment, and can be mounted without surface treatment. It can be used primarily for cyclic applications, for example for tension and compression measurements and closing-force measurements on plastic injection-molding machines. The clip-on instrument has a centrally arranged, adjustable-height contact surface for the cylindrical body, in order that the measurements can be taken exactly in the area of a diameter. However, relatively complicated manipulations are required for this purpose, and the optimum position must be searched for and set for each measurement.

### SUMMARY OF THE INVENTION

The invention is based on the object of providing a method and an apparatus of the type mentioned initially, which simplify the electrical measurement of positive and negative strains on the outer surface of essentially cylindrical bodies by means of a mobile clip-on instrument, and automate this process for the optimum position.

With regard to the method, the object is achieved according to the invention in that a first slide, which can be moved on a guide profile by means of a spindle in the tightening direction, is placed with a centering element on the cylindrical body, a second slide which can be moved on the guide profile is placed with a centering element on the cylindrical body and is latched, the centering elements are clamped onto the body between the slides by pulling on the spindle, and the measurement element or elements is or are pressed onto the outer surface of the body in order to form the force fit. Specific and developed embodiments of the method are the subject matter of dependent patent claims.

The centering elements of the slide result in the essentially cylindrical body automatically and necessarily assuming the optimum position with respect to the measurement elements of the clip-on instrument. As soon as the centering elements rest on the body, they are moved in a sprung manner with respect to the measurement elements, until they are pressed on with a force fit. When the load is removed, the centering elements spring back to their rest position.

The centering elements maintain their guidance function until a force fit is produced between the measurement element and the outer surface of the body, and once again assume it immediately when it is released.

A predetermined torque is preferably exerted on the spindle which produces the force fit by movement of the first slide. For a force fit, the contact force must be sufficiently great that all of the strains of the body surface, which is in the form of a casing, are transmitted to the strain-sensitive measurement element, expediently a strain gauge, exactly 1:1 in all directions. However, there is no point in pressing the strain-sensitive measurement elements against the outer surface of the body with a pressure which is greater than that necessary. The maximum torque which acts on the spindle is determined for this purpose, and is transmitted by means of a torque wrench or an integrated torque mechanism. The maximum torque exerted on the spindle has generally been found, as the optimum, to preferably be 2 to 5 Nm, in particular about 3 Nm.

With regard to the mobile clip-on instrument for carrying out the method, the object is achieved according to the invention in that the slides have a guide in their head area for centering elements of the cylindrical body, which can be moved in the tightening direction against the resistance of at least one return spring. Specific and developed embodiments of the clip-on instrument are the subject matter of dependent patent claims.

Even when the high contact force that is necessary to form a force fit is being exerted, the mobile clip-on instrument remains placed in a stable form on the cylindrical body, as is essential for reliable measured values. According to the invention, it is particularly important that, when exerting the contact force to produce the force fit, the sprung angled centering elements relax in comparison to a spring force which is negligible with respect to the contact force, but that the angled centering elements spring back again to their rest position when the contact force is released, in which rest position the measurement element is at a distance which depends on the diameter of the body. The expression a return spring does not just mean a spring in the traditional sense, that is to say for example a spiral, leaf or cup spring, but also equivalents which act as springs, for example an elastically compressible block, an elastic tension member, a gas volume which can be compressed and can expand, or magnets which can be pushed one inside the other. The important factor, as mentioned, is that the resistance of the return spring or springs is negligibly small in comparison to the contact force to produce the force fit, and that the clip-on instrument remains convenient to use.

The angled centering elements can preferably be replaced in the relatively narrow sense, for example three preferably essentially angled centering elements of different size for body diameter ranges from 40 to 100 mm, 100 to 160 mm and 160 to 220 mm, or four centering elements of different size for ranges from 30 to 55 mm, 55 to 100 mm, 100 to 170 mm and 170 to 240 mm.

The centering elements preferably have an angle α of 60 to 120°, in particular of 80 to 100°, for holding an essentially cylindrical body. In practice, angles of about 90° have been found to be particularly suitable.

The guide profile of the clip-on instrument preferably has a circular cross section with a flat or is rectangular, square, triangular, hexagonal or trapezoidal, and is suitable for pushing on and securing the slides. The guide profile has relatively thick walls, bearing in mind the necessary robustness. For rough position of the second slide, the guide profile expediently has a catch, for example in the form of a toothed rod or a perforation, for latching of the second slide that has been mentioned, for rough positioning. The first slide can be moved along the guide profile with a spindle. The spindle drive expediently has an integrated and adjustable rotation mechanism for limiting the torque that is transmitted.

In all the embodiments, the clip-on instrument according to the invention has the advantage over a measurement ring that it is not associated with a single essentially cylindrical body, but can be replaced with a few actions, without releasing screws or the like, from a body in order to change this. In contrast to known clip-on instruments, the centering is carried out automatically and necessarily at the correct location.

### BRIEF DESCRIPTION OF THE DRAWINGS

The invention will be explained in more detail with reference to exemplary embodiments which are illustrated in the drawing and which are also the subject matter of dependent patent claims. In the figures, in each case schematically:

FIG. 1 shows a view of a mobile clip-on instrument for electrical strain measurement, with a cylindrical body cut open,

FIG. 2 shows a plan view of the clip-on instrument shown in FIG. 1, without the cylindrical body,

FIG. 3 shows a side view of a clip-on instrument as shown in FIG. 1, with a cylindrical body, and

FIG. 4 shows a section through a measurement cell with strain gauges.

### DETAILED DESCRIPTION OF THE PREFERRED EMBODIMENT(S)

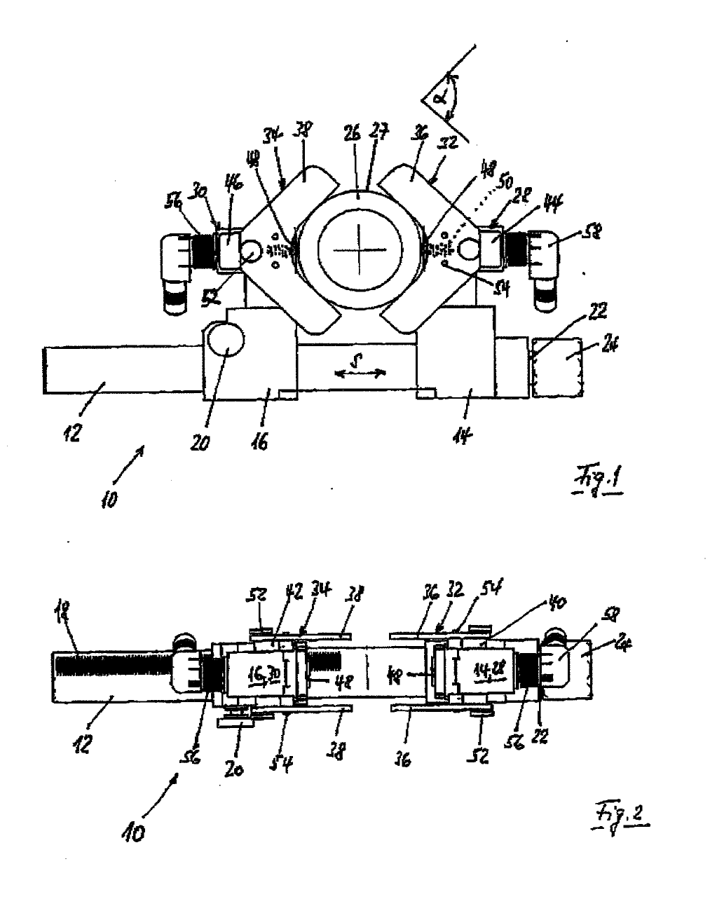

A mobile clip-on instrument 10 as shown in FIGS. 1 to 3 has a guide profile 12 with a cross section which in the present case is circular with a flat at the top. A first slide 14 and a second slide 16 are fitted to the guide profile 12, such that they cannot rotate. A toothed system 18 is formed in the area of the second slide 16, over a part of the circumference of the guide profile 12 (FIG. 2), with a comb interval of about 2 mm. The second slide 16 is unlatched from the toothed system 18 by an operating button 20, and can be moved freely along the guide profile 12. When the operating button 20 is released, a latching tab, which cannot be seen, on the second slide 16 latches in the toothed system 18, thus roughly positioning the second slide 16.

A spindle 22 which is fixed in the axial direction and has a short thread pitch passes through the first slide 14 in the tightening direction S, and engages in an internal thread. A torque setting 24 defines the maximum contact force on a cylindrical body 26, in the present case a tubular strut for a plastic injection-molding machine. The torque setting could also be provided on a normal screw head, by using a torque wrench.

The slides 14, 16 have a square slide head 28, 30, on each of which a centering element 32, 34, which is arranged in the tightening direction S, is guided such that it can move.

The configuration of the centering elements 32, 34 can be seen better in FIG. 2. Two essentially rectangular centering plates 36, 38 are in each case mounted in pairs on the outside of a carriage 40, 42, which is guided in cutouts 44, 46 on the outside of the two slide heads 28, 30. As shown in FIG. 1, the cylindrical body 26 rests on the oblique faces of the angled centering plates 36, 38, forcing them somewhat apart from one another at this stage, and the cylindrical body 26 also rests on the measurement elements 48, which in the present case are fitted on both sides.

A return spring 50, which cannot be seen and is therefore indicated by dots in FIG. 1, is arranged in the carriage, behind all the centering plates 36, 38. This return spring 50 is loaded when the centering elements 32, 34, which are resting on the cylindrical body 26, and have the right-angled centering plates 36, 38, are spread by the slides 14, 16. Compared with the contact force, the spring force of the return springs 50 is negligible, but is sufficient to return the angled centering elements 32, 34 to the rest position when the tensioning force is relaxed.

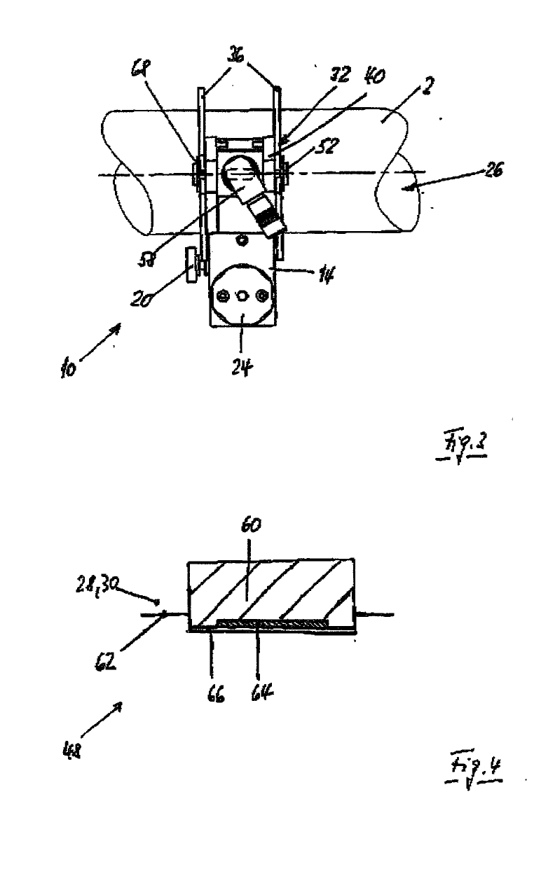

The right-angled centering plates 36, 38 are attached to the relevant carriage 40, 42 such that they can be replaced, allowing them to be replaced for different diameter ranges of the cylindrical body 26. The right-angled centering plates 36, 38 have a slot 68 at the outer apex, which slot 68 is concealed by a screw head 52 in FIG. 1, but can be seen in FIG. 3. During assembly, the screw shank is inserted into the slot 68 that has been mentioned, and guides the centering plate 36, 38, during folding into the normal position with two holes, by means of corresponding bolts 54. Once the screw heads 52 have been tightened, the right-angled centering plates 36, 38 are installed. These have only a guidance function, and do not need to absorb any contact forces.

The slide heads 28, 30 are, at the same time, measurement heads, with integrated evaluation electronics as well. Each measurement head has a screw socket or plug socket 56 for a connecting plug 58.

In the embodiment shown in FIG. 3, a cylindrical body 26 is in the form of a solid cylinder.

FIG. 4 shows a strain-sensitive measurement element 48 with an elastic element 60 which projects beyond the inner contour 62 on a measurement head 28, 30. A strain gauge 64 is placed on the outer face of the elastic element 60, and is protected by a metal foil 88 composed of steel. The strain gauge 64 can be arranged, for example, axially, radially or at an angle of 45° to the tightening direction S.

The lower face of the elastic element 60, which rests on the outer surface 27 of the cylindrical body 26, and the measurement cell 48 are flat, or are roughly matched to the radius of the body 26.

1-10. (canceled)

11. A method for electrical measurement of positive and negative strains on an outer surface of essentially cylindrical bodies, said method comprising using a mobile clip-on instrument which has a guide profile for two slides, which can be adjusted with respect to one another, for clamping a cylindrical body in a radial direction and for pressing at least one strain-sensitive measurement element onto the outer surface, forming a force fit, placing a first slide, which can be moved on a guide profile by means of a spindle in a tightening direction with a centering element on the cylindrical body, placing a second slide which can be moved on the guide profile with a centering element on the cylindrical body and latching the second slide, clamping the centering elements onto the body between the slides by pulling on the spindle, and pressing said at least one measurement element onto the outer surface of the body in order to form the force fit.

12. The method as claimed in claim 11, further comprising determining and setting a maximum torque which acts on the spindle.

13. The method as claimed in claim 12, wherein said setting strip comprises setting the maximum torque which acts on the spindle in the range of from 2 to 5 Nm.

14. The method as claimed in claim 12, wherein said setting strip comprises setting the maximum torque to about 3 Nm.

15. A mobile clip-on instrument comprising a guide profile for two slides, which can be adjusted with respect to one another, for clamping an essentially cylindrical body in a radial direction and for pressing at least one strain-sensitive measurement element onto an outer surface, forming a force fit, the slides having a guide in a head area for centering elements of the cylindrical body, which can be moved in a tightening direction against the resistance of at least one return spring.

16. The clip-on instrument as claimed in claim 15, wherein the centering elements have essentially angled centering plates, which are replaceable.

17. The clip-on instrument as claimed in claim 16, wherein the centering plates have an angle α of 60 to 120°.

18. The clip-on instrument of claim 17, wherein the angle α is from 80 to 100°.

19. The clip-on instrument as claimed in claim 15, wherein a catch is formed for latching one of the slides in the guide profile.

20. The clip-on instrument of claim 19, wherein the catch is in the form of a toothed system which has a tooth pitch of about 2 mm.

21. The clip-on instrument as claimed in claim 15, wherein the centering elements comprise two angled centering plates, which are detachably mounted on a carriage at a side, are guided in cutouts on two outer faces of the slide head and have two return springs.

22. The clip-on instrument as claimed in claim 15, further comprising a drive for a spindle having an integrated torque adjustment.

23. The clip-on instrument as claimed in claim 15, wherein a measurement head is integrated on an end face of the slide head, opposite the at least one measurement element.
